(19) United States
(12) Patent Application Publication
(10) Pub. No.: US 2026/0326815 A1
(43) Pub. Date: Oct. 22, 2026

(54) STEER-BY-WIRE HANDWHEEL ROADWHEEL DYNAMIC MISALIGNMENT TARGET CORRECTION

(71) Applicant: Steering Solutions IP Holding Corporation, Saginaw, MI (US)

(72) Inventors: Karthik Rengarajan, Rochester Hills, MI (US); Alexander Jennings, Bath, MI (US)

(21) Appl. No.: 19/055,639

(22) Filed: Feb. 18, 2025

(51) Int. Cl. B62D 5/04; B62D 5/00

(52) U.S. Cl. CPC B62D 5/0484; B62D 5/001; B62D 5/0421; B62D 5/046

(57) ABSTRACT

A method for controlling roadwheel position in a steer-by-wire (SbW) steering system of a vehicle includes, using one or more processors, receiving a rack position error indicating a difference between an actual rack position and a rack position reference, generating an alignment offset based on the rack position error, generating an adjusted roadwheel position target based on the alignment offset, and controlling a roadwheel actuator based on the adjusted roadwheel position target.

### TECHNICAL FIELD

This disclosure relates to systems and methods for controlling handwheel and roadwheel actuators in a steering system.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

This disclosure relates generally to systems and methods for controlling handwheel and roadwheel actuators in a steering system.

An aspect of the disclosed embodiments includes a method for controlling roadwheel position in a steer-by-wire (SbW) steering system of a vehicle. The method includes, using one or more processors, receiving a rack position error indicating a difference between an actual rack position and a rack position reference, generating an alignment offset based on the rack position error, generating an adjusted roadwheel position target based on the alignment offset, and controlling a roadwheel actuator based on the adjusted roadwheel position target.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 2A generally illustrates an example rack or RWA controller and column or handwheel actuator (HWA) of a steering system according to the principles of the present disclosure.

FIG. 2B is a functional block diagram illustrating an example implementation of functions and/or components of steering systems and methods according to the principles of the present disclosure.

FIG. 3 is a flow diagram generally illustrating a method for performing roadwheel position control techniques according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like. Although described herein with respect to vehicles, the principles of the present disclosure may also be implemented in other types of transportation or non-transportation apparatuses that include steering systems.

An SbW steering system may include at least one handwheel actuator (HWA), such as a steering wheel, which is used by a driver to control the vehicle laterally, and at least one roadwheel actuator (RWA), which is used to control a steered axle of the vehicle and create lateral motion of the vehicle responsive to movement of the HWA. A SbW system may further include one or more controllers, such as a domain controller, configured to store and execute control logic.

In an SbW system, the HWA may be configured to detect driver input (e.g., handwheel input), provide steering force (e.g., torque) feedback to the driver, and generate RWA targets (e.g., command target rack position) to achieve driver intended lateral motion. Conversely, the RWA is configured to execute/perform rack position control (e.g., actuate the rack) to meet the RWA position target and provide road and position feedback to the HWA (e.g., a rack force). In some conditions, roadwheel position may not align with handwheel position (and/or RWA targets), which may be referred to as misalignment between the HWA and the RWA. For example, if the RWA is slow/lagging with respect to the HWA (and/or RWA targets), the rack can continue to move toward the position target even if the handwheel has stopped moving, which can cause unintended rack movement from the perspective of the driver.

Steering systems and methods according to the present disclosure are configured to implement RWA position target techniques to generate an improved (e.g., adjusted or modified) RWA target rack or roadwheel position that minimizes position errors or misalignment between the HWA and RWA. These systems and methods provide an RWA target that ensures that roadwheels move in a same direction as handwheel velocity. Further, the RWA target as generated using the techniques of the present disclosure: (i) stops movement of the roadwheels when the handwheel stops moving; (ii) moves the roadwheels in a controllable and predictable manner such that excessive or insufficient motion is minimized or does not occur; and (iii) reduces position error (e.g., reduces position error over time). As used herein, instances of “roadwheel” may refer to roadwheel and/or rack position, error, etc.

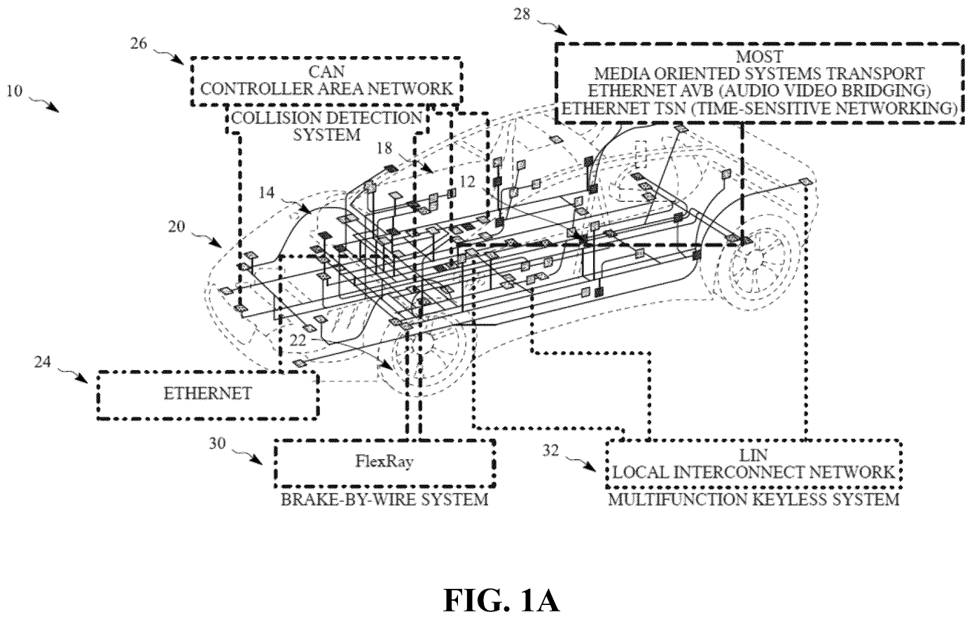

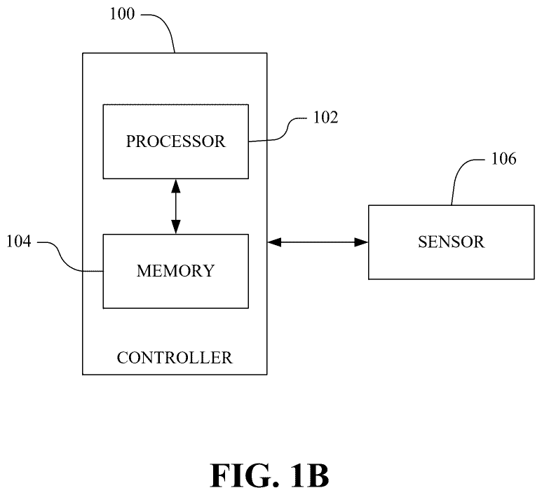

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include an electric, hybrid or a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more rack or roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10.

The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof. The one or more signals may indicate a handwheel torque, a handwheel angle, a motor velocity, a vehicle speed, other suitable information, or a combination thereof. As used herein, “sensors” may correspond to physical sensors or derived signals (e.g., signals derived from algorithms or calculations based on one or more sensor inputs both directly into the controller or using data communicated to the controller from sources outside the immediate controller area).

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B. In some examples, one or more functions may be performed remotely (e.g., relative to the vehicle), such as at a controller, processor, circuitry, etc. of a remote server, cloud computing system, and/or other remote processing system.

In some embodiments, the controller 100 may perform the methods described herein. However, the methods described herein as performed by the controller 100 are not meant to be limiting, and any type of software executed on a controller, processor, or other circuitry can implement the hysteresis shaping techniques described herein without departing from the scope of this disclosure. For example, a controller, such as a processor executing software within a computing device, may be configured to implement the systems and methods described herein.

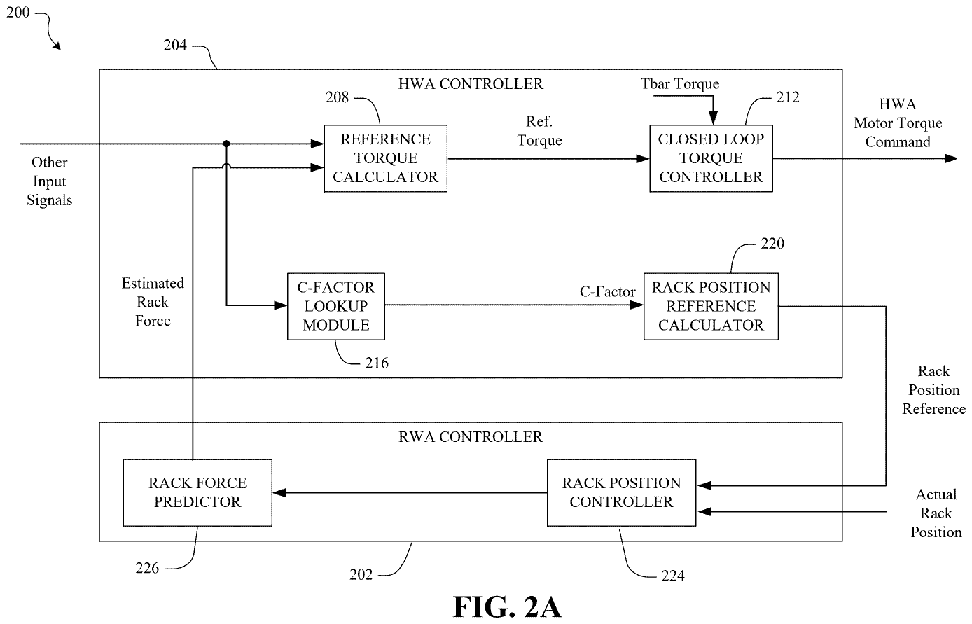

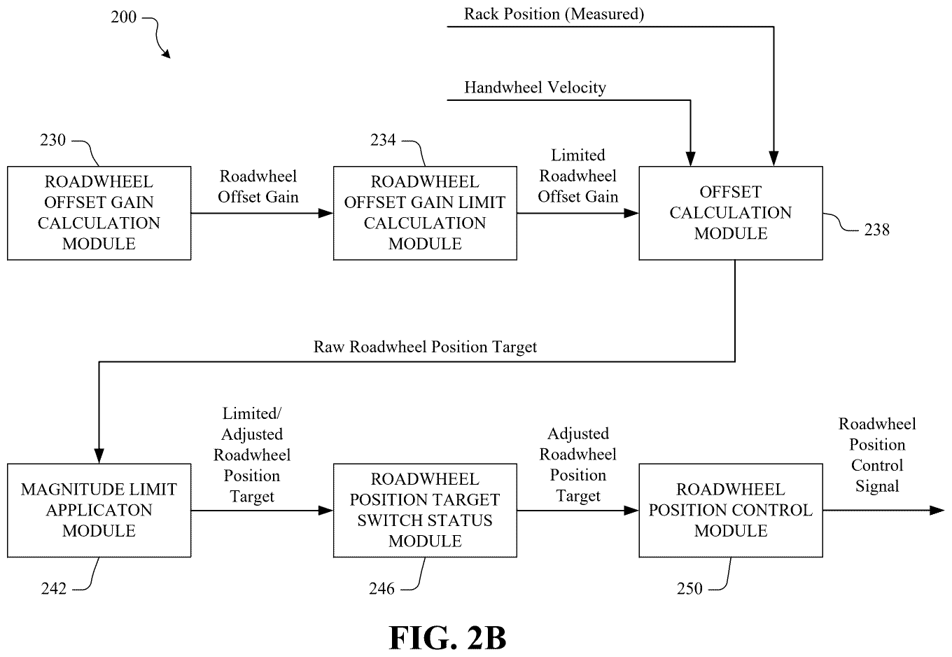

FIG. 2A illustrates an example steering system 200 including a rack or RWA controller 202 and column or handwheel actuator (HWA) controller 204 of a steering system configured to implement RWA position target techniques according to the present disclosure. The HWA controller 204 is configured to generate a handwheel actuator (HWA) motor torque command based on an estimated rack force (e.g., an estimated rack force signal) received from the RWA controller 202 and one or more other input signals (e.g., vehicle speed, handwheel position, and handwheel velocity). The RWA controller 202 is configured to determine the estimated rack force based on the motor torque required to achieve or maintain an actual rack/roadwheel position. The controllers 202 and 204 may correspond to, be implemented by, etc. one or more steering system controllers.

As one example, the HWA controller 204 includes a reference torque calculator 208 configured to calculate a reference torque (Tref) based on the estimated rack force and the one or more other input signals. For example, the reference torque corresponds to a sum of various inputs/measurements such as effort, hysteresis, return correction or CVR, damping, catch, etc. A closed loop (e.g., a PID closed loop) torque controller 212 is configured to generate and output the motor torque command based at least in part on a force or torque applied by the driver (e.g., “Tbar torque”) and the reference torque. The motor torque command is provided as a control signal to control a motor of the handwheel actuator.

The estimated rack force corresponds to the measured or estimated roadwheel actuator motor torque. Accordingly, the estimated rack force (and any estimated rack force offset or error) is a critical factor for determining the force provided by the motor of the handwheel actuator.

In some examples, the HWA controller 204 may further include a C-factor lookup module 216 and a rack position reference calculator 220. For example, the rack position reference calculator 220 is configured to generate the rack position reference based on a C-factor received from the C-factor lookup module 216. The C-factor may be determined based on a handwheel angle (“HwAg”) corresponding to driver input (e.g., a handwheel angle indicating driver intent conveyed via the handwheel) and vehicle speed. Example systems and methods for obtaining the rack position reference and the C-factor are described in more detail in U.S. patent application Ser. No. 18/318,657, filed on May 16, 2023, the entire contents of which are incorporated herein by reference.

The RWA controller 202 includes a rack position controller 224 (e.g., a PID rack position controller) configured to generate one or more rack position control signals based on the actual rack position and the rack position reference (e.g., a rack position error based on a difference between the actual rack position and the rack position reference). For example, the rack position control signals may include, but are not limited to, rack motor velocity and motor torque command (e.g., indicative of an amount of torque applied by the driver) signals. In this manner, rack position is controlled to follow the intent of the driver (as indicated by the rack reference position). In some examples, the rack position controller 224 may be configured to control rack position further based on a target rack position. For example, the rack position reference may correspond to an ideal/desired steering response. Conversely, the target rack position may correspond to an actual target position to which the steering rack should move. In other words, the target rack position may be determined based in part on the rack position reference but may be adjusted or limited in accordance with hardware or software limitations, vehicle dynamics, safety, etc.

A rack force predictor 226 generates the estimated rack force based on outputs of the rack position controller 224 (e.g., based on a function of the rack motor velocity, the rack motor torque command, etc.). In various examples, the estimated rack force can be used to provide handwheel torque resistance to the driver via the HWA. As shown, the rack force predictor 226 may output the estimated rack force and the reference torque calculator 208 (and/or another component of the RWA controller 202, the HWA controller 204, etc.) may obtain an estimated rack load based on the estimated rack force. In other examples, the rack force predictor 226 may output the estimated rack load. In some contexts, the terms “estimated rack force” and “estimated rack load” may be used interchangeably.

For example, for RWA position control, the rack position reference signal (“RackPosRef”) may be calculated based on a position error (“PosErr”) between an ADAS rack position reference value or signal (“ADASRackPosRef”) and an HWA rack position reference value or signal (“HWARackPosRef”). Conversely, HWA position control is based on a position error between the HWA position and the RWA position, such that the handwheel can be controlled to rotate in a manner consistent with rotation of the roadwheel in hands-off conditions.

The reference torque may correspond to a desired, ideal, or target torque to be felt by the driver (i.e., at the handwheel/steering wheel). As described above, the reference torque is calculated based on inputs including, but not limited to, driver input (e.g., an input torque, corresponding to steering handwheel angle), road conditions, damping, hysteresis, etc. A torque at the handwheel is controlled (e.g., via the HWA) to match the reference torque. For example, outputs of one or more sensors measuring actual torque at the wheel are used to minimize the difference between the reference torque and the actual torque.

An effort function (e.g., an effort function implemented by the reference torque calculator 208) defines a relationship between driver input (e.g., the force or torque applied by the driver to the handwheel, which may be referred to as “effort”) and a response (i.e., movement) of the steering system. For example, the effort function may output an effort value based on a lookup table or other function (e.g., by using an estimated rack load as an input). The estimated rack load may be modified prior to being input to the lookup table by adding a calculated return load value to the estimated rack load. The effort function indicates an amount of effort required by the driver to cause a desired response.

Steering systems and methods (e.g., the steering system 200) according to the present disclosure are configured to implement RWA position target techniques to generate an adjusted or modified RWA target that minimizes position errors or misalignment between the HWA and RWA as described below in more detail. For example, one or more functions of the systems and methods described below may be implemented by the HWA controller 204, such as by the rack position reference calculator 220, and/or the RWA controller, such as by the rack position controller 224. In an example, the rack position reference calculator 220 and the rack position controller 224 may be configured to perform respective functions of the techniques described below.

As one example, steering system 200 according to the present disclosure is configured to provide roadwheel actuator position target adjustments when the position/positional error between the roadwheel actuator and handwheel actuator is too large (e.g., exceeds a position error threshold). These adjustments allow the vehicle to meet the following performance criteria in scenarios where position errors occur:
Ensure that roadwheels move in a same direction as handwheel velocity;
Stop movement of the roadwheels when the handwheel stops moving;
Move the roadwheels in a controllable and predictable manner such that excessive or insufficient motion is minimized or does not occur; and
Reduce position error.

FIG. 2B is a functional block diagram illustrating an example implementation of functions and/or components of the steering systems and methods of the present disclosure. For example, one or more components of the RWA controller 202 and/or the HWA controller 204, such as the rack position reference calculator 220 and the rack position controller 224, may be configured to implement the functions shown in FIG. 2B. For simplicity, as shown in FIG. 2B, the functions will be generally described as being components and/or functions of the steering system 200. For example, the RWA controller 202 and/or the HWA controller 204 may respectively include or implement one or more of a roadwheel offset gain calculation module 230, a roadwheel gain limit calculation module 234, an offset calculation module 238, a magnitude limit application module 242, a roadwheel position target switch status module 246, and a roadwheel position control module 250 as describe below in more detail.

The roadwheel offset gain calculation module 230 is configured to generate and output a roadwheel offset gain (or, gain signal). For example, the module 230 may determine whether a roadwheel position is ahead of (leading) or behind (lagging) a roadwheel position target (a rack tracking status, such as “roadwheel ahead” or “roadwheel behind”) and generate the roadwheel offset gain accordingly. As one example, the roadwheel offset gain is calculated based on one or more of rack position error, vehicle speed, and a current C-factor or C-factor estimate, rack-based C-factor estimate gain percentages, the rack tracking status, etc.

As one example, the current rack-based C-factor estimate can be estimated by calculating a change in an actual rack position divided by a change in rack-based handwheel angle target (in revolutions). Rack-based C-factor estimate gain percentages can apply a proportional scalar to the estimated rack-based C-factor to set an increase gain and a decrease gain that correspond to roadwheel behind and roadwheel ahead statuses, respectively. The rack tracking status can be determined by multiplying a sign of the roadwheel error and a sign of the handwheel velocity, where roadwheel error is equivalent to the measured roadwheel position minus the original/actual roadwheel position target. When these signs are multiplied, a positive value indicates the roadwheel is behind the target and a negative value indicates the roadwheel is ahead of the target. In this manner, the product of the signs (a status indicator) can be used to select different gains for the roadwheel offset gain.

The roadwheel offset gain limit calculation module 234 is configured to calculate and apply one or more roadwheel offset gain limits or limiters to the roadwheel offset gain to obtain a limited roadwheel offset gain. For example, the module 234 limits the gain to a maximum and minimum value (e.g., to a value between maximum and minimum limits), which may depend on various calibrations, vehicle dynamic states (e.g., vehicle dynamics estimates), etc. Vehicle dynamics estimates may include vehicle bicycle models, vehicle speed-based calibrations, dual track vehicle models, etc. Rack gain slew rates can be applied to limit how quickly the rack gain can change (e.g., using one or more of a closed loop velocity controller, a rack velocity-based scalar, a rack velocity-based calibration gain or offset, and a rack velocity-based limiter. In some examples, the estimated C-factor/steering ratio can impact the maximum and minimum limits.

The offset calculation module 238 is configured to calculate an offset and apply the offset to a measured rack position to obtain and output a (raw or unmodified) roadwheel position target. For example, the offset may be directly proportional to handwheel velocity, a target adjusted gain (i.e., the limited roadwheel offset gain), the software execution time step, and a calibratable plant gain adjustment. Accordingly, the offset may be calculated by multiplying the offset gain by the handwheel velocity, the time step, and the calibratable gain. The offset can then be added to the measured rack position (e.g., a current rack position).

For example, the software executable time step may be a calibratable value or a dynamically calculated execution time difference estimate. The plant gain can be a calibratable or predetermined value, a calibration dependent upon vehicle dynamics inputs (vehicle speed, yaw rate, lateral acceleration, etc.), a calculated plant tracking capability model, etc. In other examples, the plant gain can be based on rack velocity, closed loop controls (e.g., PID or LQR control system), etc. Handwheel velocity can be estimated as the change in handwheel position either with respect to time or with respect to time steps, and can contain units including degrees per second, radians per second, or revolutions per second.

The magnitude limit application module 242 is configured to apply further limiters or limits to the raw roadwheel position target to obtain and output a limited roadwheel position target. For example, the module 242 may calculate and apply one or more limits using vehicle model-based dynamic limits, vehicle speed-dependent calibratable limits, or constant magnitude limits, and can estimate minimum and maximum roadwheel positions based on an allowable vehicle level dynamics metric. The vehicle dynamics model may include a bicycle model, a dual track model, and/or a vehicle speed-dependent estimate. The vehicle dynamics metric may include at least one of an allowable vehicle lateral acceleration error, an allowable vehicle yaw rate error, an allowable vehicle lateral position error, an allowable vehicle lateral velocity error, and/or an allowable vehicle yaw acceleration error.

The roadwheel position target switch status module 246 can selectively activate or deactivate the application/use of the (limited/adjusted) roadwheel position target. In other words, depending on various conditions, the roadwheel position target calculated in accordance with the techniques of the present disclosure may be used or not used. When not used, an original or actual position target (i.e., the original, unmodified/unadjusted position target) can be used. For example, the adjusted roadwheel position target with the offset applied using the techniques of the present disclosure may not be used in certain conditions.

As one example, the module 246 may activate/apply the adjusted roadwheel position target: in response to the rack position error exceeding a rack position error threshold or a vehicle speed-dependent rack position error threshold; based on a vehicle model-based rack error allowed estimate; in response to a roadwheel velocity error exceeding a roadwheel velocity error threshold; and/or in response to a roadwheel acceleration exceeding a roadwheel acceleration threshold.

The roadwheel position control module 250 calculates and outputs a roadwheel position control signal based on the adjusted roadwheel position target (e.g., to control the RWA to move the rack based on the adjusted roadwheel position target). As one example, the module 250 implements a blend function to smoothly transition from the original roadwheel target to the adjusted roadwheel position target or from the adjusted roadwheel position target to the original roadwheel target. The blend function may include a clipping mechanism configured to clip or limit the adjusted roadwheel position target based on the original roadwheel target command magnitude, the handwheel velocity, roadwheel error direction, and/or an adjusted roadwheel target command. The blend function may include a timed transition that triggers upon detecting a source switch (e.g., as activated by the roadwheel position target switch status module 246). During a transition state (e.g., while transitioning between the original and adjusted roadwheel position target), the position target can be slewed, blended, or adjusted based on time-dependent slew rates, filtered transitions, and/or an error-dependent percentage gain shift.

In some examples using the techniques described herein, the adjusted roadwheel position target is calculated in accordance with:

Rack Pos Target Adj=Rack Pos Actual+Alignment Offset,

where Rack Pos Target Adj is the adjusted roadwheel position target, Rack Pos Actual is the original or actual rack position, and Alignment Offset is the offset (e.g., as calculated by the offset calculation module 238).

The alignment offset can be calculated in accordance with:

Alignment Offset=Gain*Handwheel Velocity*Sample Time.

The gain can be calculated as a function of rack position error (Rack Pos Error), handwheel position (Hw Pos), handwheel velocity (Hw Vel), and vehicle speed (VehSpeed):

Gain=fn(Rack Pos Error, Hw Pos, Hw Vel, VehSpeed).

Accordingly as described herein, a target offset gain depends on whether the roadwheel is ahead or behind target roadwheel position, such that the target offset gain increases when the roadwheel is behind and decreases when the roadwheel is ahead. This helps the function reduce positional error faster and enables enhanced flexibility improve smoothness and control. If the rack is lagging an ideal rack position, the gain is scaled up, bounded by stability-based limits. If the rack is leading the ideal rack position, the gain is scaled down and clipped based a minimum rack movement that the driver can intuitively use to control the vehicle for a given handwheel velocity. The target offset gain contains at least one magnitude or change rate limiter, which provides protections for the roadwheel position target adjusted calculation by adding safety limits to ensure the driver's inputs lead to safe, controllable rack movement. A final alignment offset can be bounded by rack actuator end point limits, vehicle dynamic-based limits to account for actuator protection, and vehicle stability.

Further, roadwheel position target adjusted raw dynamic magnitude limiters enhance safety protections by providing limits on software outputs in case of software faults to mitigate the risk of a hazard. Rack velocity feedback can be used to manage or limit rack velocity while roadwheel position target adjusted is actively altering the command. In this manner, these techniques ensure that the roadwheel controller does not move too quickly to meet the adjusted roadwheel position target.

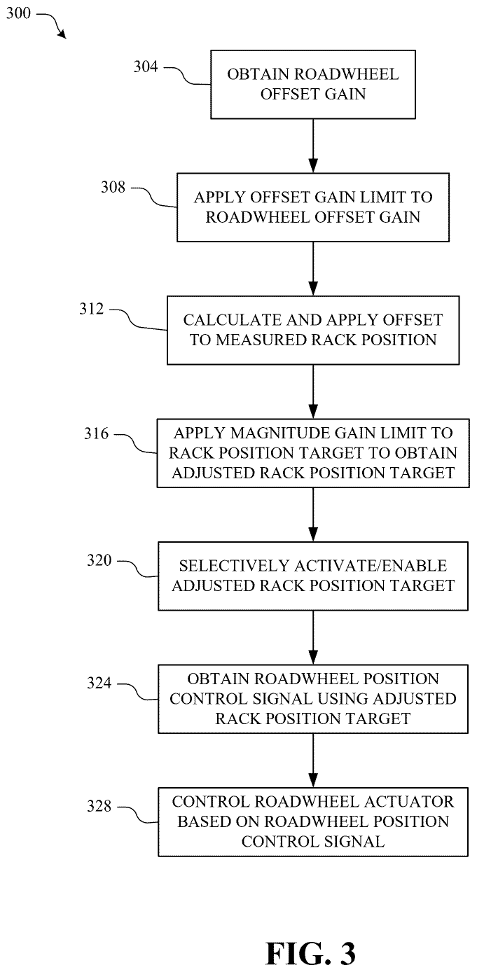

FIG. 3 is a flow diagram generally illustrating a method 300 for performing roadwheel position control techniques according to the principles of the present disclosure. For example, one or more computing devices, processors, or processing devices, etc. are configured to execute instructions to implement the method 300, such as one or more of the processors of the systems described herein (e.g., a computing device or processor of a vehicle configured to implement the controller 100, the system 200, etc.). One or more of the steps of the method 300 as described below may be skipped or omitted in some examples, and/or one or more of the steps may be performed in a different sequence than described.

At 304, the method 300 includes obtaining a roadwheel offset gain. For example, the roadwheel offset gain is calculating based at least in part on a determination of whether a roadwheel position is ahead of (leading) or behind (lagging) a roadwheel position target. At 308, the method 300 includes applying an offset gain limit to the roadwheel offset gain.

At 312, the method 300 includes calculating and applying an offset to a measured rack position to obtain and output a roadwheel position target. For example, the offset can be calculated based on at least the roadwheel offset gain and the handwheel velocity. Applying the offset includes adding the offset to the measured rack position.

At 316, the method 300 includes obtaining and applying a magnitude limit to the roadwheel position target to obtain an adjusted roadwheel position target. At 320, the method 300 includes selectively activating/enabling the adjusted roadwheel position target.

At 324, the method 300 includes obtaining a roadwheel position control signal using the adjusted roadwheel position target. For example, obtaining the roadwheel position control signal may include applying a blend or blending function to transition between (to or from) an original roadwheel position target and (from or to) the adjusted roadwheel position target. In other words, rather than abruptly or instantaneously stepping from the original to the adjusted roadwheel position target, the transition may be performed gradually over a predetermined period. At 328, the method 300 includes controlling the RWA based on the roadwheel position control signal.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such. As used herein, the term “approximately” may correspond to within “+/−5.0% of.”

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the present disclosure is intended to cover various modifications and equivalent arrangements included within the scope of the appended claims, which scope is to be accorded the broadest interpretation so as to encompass all such modifications and equivalent structure as is permitted under the law.

1. A method for controlling roadwheel position in a steer-by-wire (SbW) steering system of a vehicle, the method comprising, using one or more processors:
receiving a rack position error indicating a difference between an actual rack position and a rack position reference;
generating a roadwheel offset gain based on the rack position error, wherein generating the roadwheel offset gain includes (i) determining whether a roadwheel position is ahead of or behind a roadwheel position target, (ii) increasing the roadwheel offset gain in response to a determination that the roadwheel position is behind the roadwheel position target, and (iii) decreasing the roadwheel offset gain in response to a determination that the roadwheel position is ahead of the roadwheel position target;
generating an alignment offset based on the roadwheel offset gain;
generating an adjusted roadwheel position target based on the alignment offset; and
controlling a roadwheel actuator based on the adjusted roadwheel position target.

2. (canceled)

3. The method of claim 1, further comprising generating the roadwheel offset gain further based on at least one of a handwheel position, a handwheel velocity, and a vehicle speed.

4. (canceled)

5. The method of claim 1, further comprising limiting the roadwheel offset gain based on a vehicle dynamic state.

6. The method of claim 1, wherein the alignment offset is generated further based on a handwheel velocity and a sample time.

7. The method of claim 1, further comprising selectively limiting the adjusted roadwheel position target based on a vehicle dynamic state.

8. The method of claim 1, further comprising selectively enabling the adjusted roadwheel position target based on at least one of a rack position error threshold, a rack or roadwheel velocity error threshold, and a rack or roadwheel acceleration threshold.

9. The method of claim 1, further comprising transitioning from an original roadwheel position target command to the adjusted roadwheel position target over a predetermined period.

10. A processor configured to execute instructions stored in memory, wherein executing the instructions causes the processor to control roadwheel position in a steer-by-wire (SbW) steering system of a vehicle by:
receiving a rack position error indicating a difference between an actual rack position and a rack position reference;
generating a roadwheel offset gain based on the rack position error, wherein generating the roadwheel offset gain includes (i) determining whether a roadwheel position is ahead of or behind a roadwheel position target, (ii) increasing the roadwheel offset gain in response to a determination that the roadwheel position is behind the roadwheel position target, and (iii) decreasing the roadwheel offset gain in response to a determination that the roadwheel position is ahead of the roadwheel position target;
generating an alignment offset based on the roadwheel offset;
generating an adjusted roadwheel position target based on the alignment offset; and
controlling a roadwheel actuator based on the adjusted roadwheel position target.

11. (canceled)

12. The processor of claim 10, the instructions further causing the processor to generate the roadwheel offset gain based on at least one of the rack position error, a handwheel position, a handwheel velocity, and a vehicle speed.

13. The processor of claim 10, the instructions further causing the processor to generate the roadwheel offset gain based on a determination of whether a roadwheel position is ahead of or behind a roadwheel position target.

14. The processor of claim 10, the instructions further causing the processor to limit the roadwheel offset gain based on a vehicle dynamic state.

15. The processor of claim 10, wherein the alignment offset is generated further based on at least one of a handwheel velocity and a sample time.

16. The processor of claim 10, the instructions further causing the processor to selectively limit the adjusted roadwheel position target based on a vehicle dynamic state.

17. The processor of claim 10, the instructions further causing the processor to selectively enable the adjusted roadwheel position target based on at least one of a rack position error threshold, a rack or roadwheel velocity error threshold, and a rack or roadwheel acceleration threshold.

18. The processor of claim 10, the instructions further causing the processor to transition from an original roadwheel position target command to the adjusted roadwheel position target over a predetermined period.

19. A steer-by-wire (SbW) system for a vehicle, the SbW system comprising:
a processor configured to execute instructions stored in memory, wherein executing the instructions causes the processor to control roadwheel position by:
receiving a rack position error indicating a difference between an actual rack position and a rack position reference;
generating a roadwheel offset gain based on the rack position error, wherein generating the roadwheel offset gain includes (i) determining whether a roadwheel position is ahead of or behind a roadwheel position target, (ii) increasing the roadwheel offset gain in response to a determination that the roadwheel position is behind the roadwheel position target, and (iii) decreasing the roadwheel offset gain in response to a determination that the roadwheel position is ahead of the roadwheel position target;
generating an alignment offset based on the roadwheel offset gain;
generating an adjusted roadwheel position target based on the alignment offset; and
controlling a roadwheel actuator based on the adjusted roadwheel position target.

20. The SbW system of claim 19, the instructions further causing the processor to:
generate the roadwheel offset gain further based on at least one of a handwheel position, a handwheel velocity, and a vehicle speed.
